(19) United States
(12) Patent Application Publication
(10) Pub. No.: US 2008/0099593 A1
(43) Pub. Date: May 1, 2008

(54) Roll of Absorbent Paper For Sanitary or Domestic Use With a Lateral Groove

(75) Inventors: Remy Ruppel, Durrenentzen (FR); Gilles Cattacin, Colmar (FR); Arnaud Jaegler, Boofzheim (FR)

Correspondence Address: PATENT GROUP GA030-43;GEORGIA-PACIFIC LLC, 133 PEACHTREE STREET, N.E., ATLANTA, GA, 30303-1847, US

(73) Assignee: GEORGIA-PACIFIC FRANCE, Kunheim (FR)

(21) Appl. No.: 11/877,176

(22) Filed: Oct. 23, 2007

(30) Foreign Application Priority Data
Oct. 30, 2006 (FR) 06 09510

(51) Int. Cl. A47K 10/24; A47K 10/22; A47K 10/38; B31F 7/00; B65D 85/67

(52) U.S. Cl. 242/160.1; 206/389; 242/590; 492/20

(57) ABSTRACT

A material control groove is pressed into one of the lateral faces of a dispenser roll of absorbent paper in the form of a continuous sheet rolled about an axis forming helical coils, provided in the form of a groove defining a closed contour about the axis such that the width of the sheet forming the coils spaced axially inward of the groove is reduced by displacement of portions of the continuous sheet in a direction parallel to the axis.

This application claims priority to copending French patent application number 06 09510, filed Oct. 30, 2006, the disclosure of which is incorporated herein by reference.

The present invention relates to the field of paper for sanitary or domestic use. Its subject is a roll of paper comprising an annular groove formed in at least one end thereof and its method of manufacture.

In this field, the invention is aimed particularly at toilet paper, tissue paper used especially as a household towel or hand-wipe. These papers are presented to the user for example in the form of rolls consisting of one sheet, where appropriate pre-cut into sections, rolled about a central axis. The rolls may be of a type with or without a spindle and in the latter case, with or without a central hole. To make them convenient to use, the rolls are usually placed in an appropriate dispenser.

When the intended use falls outside the domestic circle, in collective establishments, particularly such as hotels, restaurants, hospitals or other establishments, the dispensers are produced to perform a plurality of functions. These are storing the paper, maintaining the hygiene of the product, controlling the consumption of the paper or else preventing the use of non-compliant rolls; as paper manufacturers often supply dispensers at prices substantially below full price to users who agree to dispense only that paper manufacturers' products through the dispenser; but some users neglect to use that paper manufacturers' products in these dispensers.

For the latter case and also to provide continuous guidance throughout the consumption of the roll and satisfactory dispensing of the sheet, when the roll has a spindle in particular, systems have been proposed that comprise protrusions or lugs that protrude relative to one of the lateral faces of the roll support. These protrusions or lugs are annular or off-centre relative to the axis of the roll and interact with a groove of matching shape made on the adjacent lateral face or end of the roll.

To produce this groove on the roll, a known means consists in cutting out the sheet appropriately while it is rolled about the axis of the roll or else of a spindle. Patent EP 380 438 describes a method with cutting of a sheet of great width into several sheets of smaller width matching that of the rolls to be manufactured. Use is made of a plurality of blades parallel with one another which make a continuous cut of the wide sheet. Retractable blades cut additional strips of a width corresponding to the depth of the groove over a determined length depending on the width of the groove to be formed.

According to another known method, after the roll is formed, the groove is cut by means of a cutting tool. It is observed that all the known methods are limited to a solution in which the groove is obtained by removing material.

The applicant has sought to enhance the technique of forming the groove. One objective has been the development of a method that is simpler to apply than cutting the strip of material while it is rolled. Specifically, the latter method is disadvantageous when it involves manufacturing products at a high rate as is required on modern production machines.

The applicant has also sought to enhance the quality of the product. Even though the groove is of reasonable depth, the result thereof is a lack of material on the sections level with the groove.

According to the invention, the roll of absorbent paper for sanitary or domestic use, comprising a continuous sheet rolled about an axis and forming a plurality of helical coils forming layers about the axis, provided, on at least one of its ends or lateral faces, with a groove defining a closed contour about this axis, is characterized in that the width of the sheet forming the coils level with, or aligned with, the groove is reduced by deformation and/or by compression of the coil in a direction parallel to the axis.

Reduction by deformation makes it possible, when the sheet is unrolled at the groove, to retrieve, by opening out, virtually the whole width. This is possible because the paper for sanitary or domestic use is an absorbent paper, the wadding being made of cellulose, of low basis weight, whose feature is to be extremely flexible.

An advantage that stems from the foregoing is that it allows a deeper groove to be formed. A protrusion of greater height interacting with a deeper groove provides more effective guidance.

Another advantage is that it allows varied shapes of groove, polygonal, for example, or simply circular.

Preferably, the groove has a U-shaped cross section with two edges extending parallel to the axial direction and parallel with one another, and more particularly the bottom of the groove is curved.

The applicant is aware of patent U.S. Pat. No. 3,038,598 which mentions the formation of a V-section groove by compression. It should be noted that an axial movement of a V-section punch whose branches are inclined relative to this direction leads to a lateral crushing of the coils. This is possible because the absorbent paper is flexible and of low density. However, the maintenance of such a shape over time is not guaranteed because the paper, due to its elasticity, tends to resume its initial shape. In addition, the guidance is not satisfactory compared with a U-section groove.

The present invention applies to any type of roll of absorbent paper, especially with a central hole and in this case preferably with a cylindrical spindle.

The invention also relates to a manufacturing method according to which, after having formed the roll, one end or lateral face of the roll is deformed by compression by means of a punch or tool comprising a rib of a shape matching that of the desired groove.

When the roll has a central hole, the punch advantageously comprises a central cylindrical boss with a diameter matching that of the hole.

Other features and advantages will emerge from the following description of a non-limiting embodiment with reference to the drawings in which:

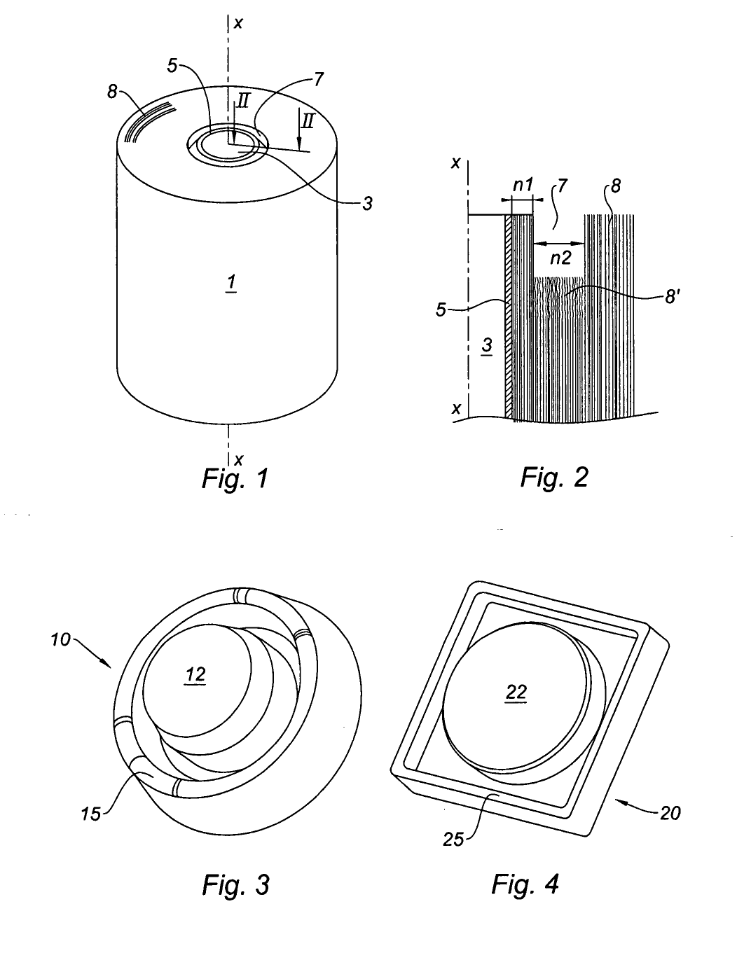

FIG. 1 shows a roll with groove in perspective.

FIG. 2 shows a cut in the direction II-II of FIG. 1

FIG. 3 shows the tool with which the groove is formed.

FIG. 4 shows a tool variant.

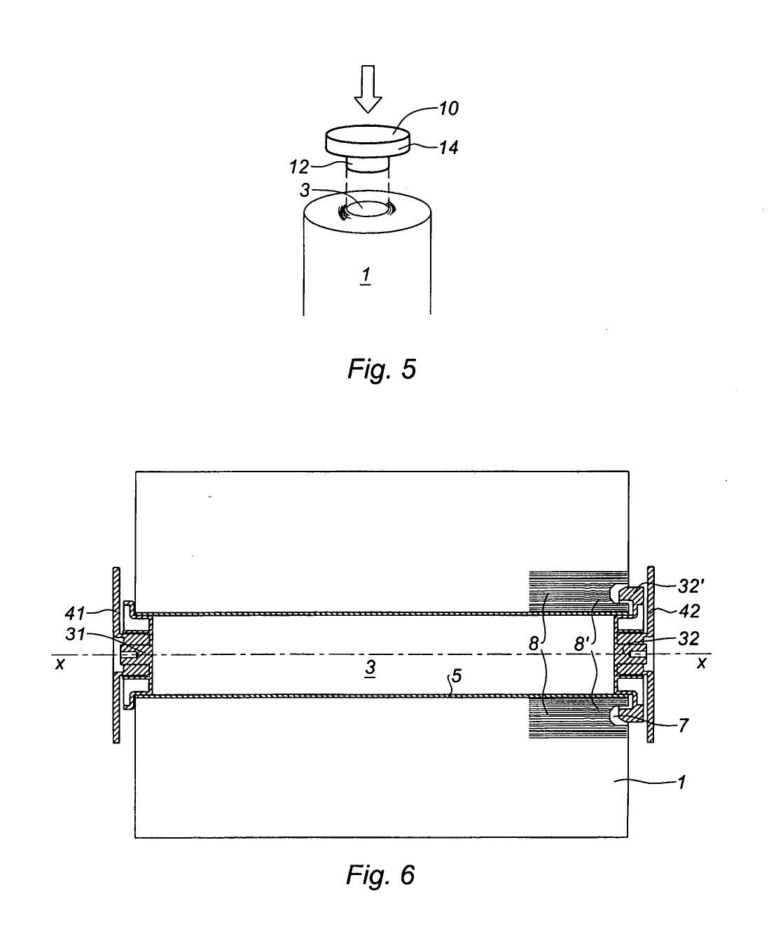

FIG. 5 shows the placement of the tool and the formation of the groove.

FIG. 6 shows, in section, the roll of the invention in place in a dispenser with appropriate support means.

The roll shown in FIG. 1 is a roll 1 for example of toilet paper with a central hole 3. The continuous sheet is rolled about a cardboard spindle 5. The absorbent paper is made of single-ply or multi-ply cellulose wadding, usually with a basis weight lying between 15 and 40 g/m² per ply. The invention relates more to use in a collective institution with rolls of larger dimension than for domestic use.

The roll comprises, on at least one lateral face, a circular groove close to the central hole 3. FIG. 2 shows the detail of the roll seen in axial section at the groove. The central hole 3 inside the spindle 5 and the helical coils 8 of the sheet that has been rolled about the spindle can be seen. From the spindle, rolling comprises a certain number n1 of coils of sheet of the same width as the roll. Then a number n2 of coils has a lesser width than that of the roll. These n2 coils define the groove 7 on the side of the roll. The sheet forming these n2 coils is deformed by compression parallel to the axis XX of the roll. It forms wrinkles 8′ over a short distance level with the groove 7. Because of the low density of the absorbent paper and to the extent that the tightness of the rolling allows, the n2 coils are deformed individually and the wrinkles of the wrinkled zone are not nested in one another.

This groove is obtained by pressing a tool as shown in FIG. 3 directed parallel to the axis XX. This tool 10 comprises a central portion 12 with a diameter equal to that of the hole 3 of the roll and forming a boss. This central portion 12 makes it possible to centre the roll properly before the deformation phase. The central portion here is bevelled to make it easier to insert into the hole 3. The tool has an annular rib 15 with a U-shaped section with a summit that is rounded or flattened but has no sharp edge. The central portion 12 is higher than the annular portion. The groove is formed, as shown in FIG. 5, by inserting the tool with its central portion into the hole 3, and by applying an axial pressure so as to compress the roll along the annular rib 15. The end or lateral face of the roll is thus deformed down to the required depth and at most over the whole height of the annular rib. Portions of the sheet forming the coils under the tool are deformed axially with formation of the wrinkles 8′ that are seen in FIG. 2. The central portion 12 of the tool 10 forms a guide for positioning the groove relative to the axis XX.

The layout of the groove may be of any shape; it depends on the shape of the guide lug or protrusion that has been chosen on the roll support. FIG. 4 shows another example of a tool 20 with a rib 25 of polygonal layout about its central portion 22 which remains circular. The principle is the same as above.

In all cases, the aim is to obtain a groove 7 defining a closed contour about the axis XX.

FIG. 6 shows in axial section, the roll 1 mounted on its dispenser of which all that is shown is the portion forming the support of the roll. The roll 1 with its spindle 5 and its groove 7 is held by two cylindrical plugs 31 and 32 engaged in the spindle at its ends. These plugs can be rotated about pivots, 41 and 42 respectively, fixedly attached to the side walls of the dispenser.

On the face comprising the groove 7, the plug 32 comprises an annular rib 32′ of a radius and width suitable for fitting in the groove 7.

The invention is not limited to the embodiment represented in the figures. It embraces all the equivalents within the scope of those skilled in the art.

1. A roll of absorbent paper, comprising a continuous sheet rolled about an axis, forming helical coils, provided, on at least one of its lateral faces, with a groove defining a closed contour about the axis, characterized in that the width of the sheet forming the coils spaced axially inward of the groove is reduced by displacement of portions of the continuous sheet in a direction parallel to the axis.

2. The roll of paper according to claim 1 which the bottom of the groove is curved.

3. The roll of paper according to claim 1 wherein the layout of the groove defines a circular contour.

4. The roll of paper according to claim 1, wherein the layout of the groove defines a polygonal contour.

5. The roll of paper according to claim 1, wherein the groove has a U-shaped cross section defining two legs of the U extending generally parallel to the axial direction, the two legs being parallel with one another.

6. The roll of paper according to claim 5 which the bottom of the groove is curved.

7. The roll of paper according to claim 6 wherein the layout of the groove defines a circular contour.

8. The roll of paper according to claim 6, wherein the layout of the groove defines a polygonal contour.

9. The roll of paper according to claim 6 further comprising a central hole.

10. The roll of paper according to claim 9 further comprising a cylindrical spindle having the sheet rolled thereabout.

11. A method of manufacturing a roll of absorbent paper having a continuous sheet forming helical coils rolled about an axis, said roll being provided, on at least one of its lateral faces, with a groove defining a closed contour about the axis, wherein the groove is formed after formation of the roll by reducing the width of the sheet forming the coils spaced axially inward of the groove by displacement of portions of the continuous sheet in a direction parallel to the axis by pressing a tool comprising a rib of a shape matching that of the groove against one lateral face of the roll.

12. The method of manufacturing a roll of absorbent paper according to claim 11 in which the portion of the rib which forms the bottom of the groove is curved.

13. The method of manufacturing a roll of absorbent paper according to claim 11 wherein the layout of the rib which forms the groove defines a circular contour.

14. The method of manufacturing a roll of absorbent paper according to claim 11 wherein the layout of the rib which forms the groove defines a polygonal contour.

15. The method of manufacturing a roll of absorbent paper according to claim 11 in which the portion of the rib which forms the sidewalls of the groove has a U-shaped cross section defining two legs of the U extending generally parallel to the axial direction, the two legs being parallel with one another.

16. The method of manufacturing a roll of absorbent paper according to claim 15 in which the portion of the rib which forms the bottom of the groove is curved.

17. The method of manufacturing a roll of absorbent paper according to claim 16 wherein the layout of the rib which forms the groove defines a circular contour.

18. The method of manufacturing a roll of absorbent paper according to claim 16 wherein the layout of the rib which forms the groove defines a polygonal contour.

19. The method of manufacturing a roll of absorbent paper according to claim 16 wherein said roll of absorbent paper has a central hole defined therein.

20. The method of manufacturing a roll of absorbent paper according to claim 19 wherein said roll of absorbent paper further comprises a cylindrical spindle and coils of the sheet are rolled thereabout.

21. A method of manufacturing a roll of absorbent paper having a central axial hole having an axis of rotation, a continuous sheet forming helical coils rolled about said axis, said roll being provided, on at least one of its lateral faces, with a groove defining a closed contour about the axis, wherein the groove is formed after formation of the roll by reducing the width of the sheet forming the coils spaced axially inward of the groove by displacement of portions of the continuous sheet in a direction parallel to the axis by pressing a tool comprising a central cylindrical guide boss with a diameter matching that of the hole and a rib of a shape matching that of the groove against one lateral face of the roll.

22. The method of manufacturing a roll of absorbent paper according to claim 21 wherein the layout of the rib which forms the groove defines a polygonal contour.

23. The method of manufacturing a roll of absorbent paper according to claim 21 in which the portion of the rib which forms the sidewalls of the groove has a U-shaped cross section defining two legs of the U extending generally parallel to the axial direction, the two legs being parallel with one another.

24. The method of manufacturing a roll of absorbent paper according to claim 23 wherein the layout of the rib which forms the groove defines a polygonal contour

25. The method of manufacturing a roll of absorbent paper according to claim 24 in which the portion of the rib which forms the bottom of the groove is curved.
